(19) United States
(12) Patent Application Publication
(10) Pub. No.: US 2014/0022109 A1
(43) Pub. Date: Jan. 23, 2014

(54) RADAR FIELD OF VIEW EXPANSION WITH PHASED ARRAY TRANSCEIVER

(71) Applicants: Jae Seung Lee, Ann Arbor, MI (US); Paul Donald Schmalenberg, Ann Arbor, MI (US)

(72) Inventors: Jae Seung Lee, Ann Arbor, MI (US); Paul Donald Schmalenberg, Ann Arbor, MI (US)

(73) Assignee: Toyota Motor Engineering & Manufacturing North America, Inc., Erlanger, KY (US)

(21) Appl. No.: 13/555,864

(22) Filed: Jul. 23, 2012

(51) Int. Cl. G01S 13/93

(52) U.S. Cl. 342/70

(57) ABSTRACT

Examples of the invention include radar apparatus having at least two phased array transmitters, each having a different elevation corresponding to heights of detected targets relative to the road surface. A low elevation transmit beam is directed at the road surface, and used to identify metal objects in the road surface, which often cause false detections in conventional devices but may not be actual collision hazards. A higher elevation transmitted beam is used to detect actual collision hazards to the vehicle.

### FIELD OF THE INVENTION

The invention relates to radar apparatus, such as phased array radar.

### BACKGROUND OF THE INVENTION

Radar apparatus are useful for various applications, for example collision avoidance in improved vehicular cruise controls. It would be very useful to develop improved radar, for example radar apparatus that is less susceptible to false detections.

### SUMMARY OF THE INVENTION

Examples of the present invention include an improved automotive radar apparatus. The apparatus includes a receive antenna array, one or more transmit antenna arrays, and electronic circuitry for analyzing the radar signal. In some examples, a single RF (radio frequency) chip includes receiver phase shifters, transmitter phase shifters, and RF mixers for both the transmit and receive arrays. The presence of two RF mixers on the chip allows two independent beams to be steered simultaneously, e.g. for both receive and transmit beam control. The transmit and receive beams may be steered together so that the transmit grating null aligns with the receive grating null, allowing the field of view to be increased.

In some examples, the transmit circuit includes transmit antenna arrays having a plurality of elevations, for example two elevations. A first transmit beam is directed towards the road surface, and allows detection of metal objects that are either part of the road surface or otherwise generally flush with the road surface. Such objects often give false detections (i.e. false detection of collision hazards) which may trigger an emergency stop in a conventional ACC system. However, using a transmit beam directed towards the road surface allows such metal objects to be detected, and allows significant reduction in false detections. Another transmit beam is directed at a higher elevation, towards potential collision hazards on the road surface, such as other vehicles.

Examples of the present invention also include improved beam control methods, which allow a grating lobe in the transmit beam and a grating lobe in the receive beam to be generally aligned, reducing the effects of grating lobes within the detected signal. For example, the transmit and receive beams may be steered cooperatively so that the main lobe of the transmit beam always remains within the main lobe of the receive beam. For example, the main lobe alignments of the transmit and receive beam can be maintained within a maximum angular separation of each other, for example less than 10 degrees.

The use of a phased array on both the receive beam and the one or more transmit beams allows these beams to be simultaneously controlled, without limiting the radar field of view. This wide field of view is achieved without experiencing problems due to the grating lobe in either the receive or transmit beams.

In some examples, the radar circuit may be dynamically reconfigured to allocate an adjustable number of channels to each of the transmit and receive antenna circuits. For example, the transmit circuit may be dynamically reconfigured to two or more elevations. Similarly, the receive circuit may be configured to receive beams from two or more elevations. For example, the transmit antenna array may include a first elevation directed towards the road surface, with a corresponding receive antenna array receiving signals back from the road surface.

Examples of the present invention allow improved discrimination between targets which may pose a collision threat, and other objects creating a radar signal that may not pose a collision threat. Examples of the latter include grates, manhole covers, and metal plates within the road surface, and also the metal road surfaces of some bridges.

An example radar apparatus, for a land vehicle configured to travel along a road, includes phased array transmitters having different elevations, generating transmit beams of different elevations. In this context, elevation refers to the height of detected objects relative to the road surface. At least one low elevation beam is directed towards the road surface, and used to detect potential targets that may otherwise create false detections, such as metal objects in the road. For example, a metal object in the road surface may not be a collision hazard, the vehicle being capable of driving over it without incident, but such objects may result in a false detection of a collision hazard due to induced radar receive signals A higher elevation beam is used to detect actual collision hazards, such as other vehicles, metal barriers, poles, pedestrians, cyclists, and the like. The receive signals induced by the transmit beams are analyzed, and objects generating a response to the low elevation beam (e.g. above a predetermined receive signal threshold) are identified as potential false detections. The higher elevation beam may be steered around such potential false detections. Alternatively, receive signals induced by the higher elevation beam may be analyzed, possibly in conjunction with the low elevation signals, to identify actual collision hazards and false detections. For example, an object giving a false detection may induce a receive signal from a low elevation beam directed towards the road surface, but not generate no (or a substantially reduced) receive signal from a higher elevation beam. A control signal to an ACC may be generated in response to actual collision hazards, and false responses to false detections are avoided.

An example radar apparatus includes one or more receive beams. For example, receive beams may be detected from the higher and lower elevation transmit beams using a single receive beam, or two receive beams with matching elevations if desired.

A radar controller includes an electronic circuit, and may be used to steer transmit beams and receive beam(s). Transmit and receive beams may be steered together, using phased array approaches, to align grating lobes of the transmit and receive beams. For example, the main lobe of the transmit and receive beam may be angularly aligned as the beams are steered across the field of view of the antenna. Steering of both transmit and receive beams increases the available field of view.

### BRIEF DESCRIPTION OF THE FIGURES

FIG. 1 shows a simplified schematic of an RF chip, connected to a receive antenna array and two transmit antenna arrays having different elevations.

FIGS. 2A to 2C show different architectures which may be used for either transmit or receive antenna arrays.

FIG. 3 shows the angular response of the receiver, transmitter, and combined operation.

FIG. 4 shows a simplified schematic, including a receive phased array and two transmit phased arrays having different elevations.

### DETAILED DESCRIPTION OF THE INVENTION

Examples of the invention include a radar apparatus including two receive antenna arrays, each receive antenna array having a dedicated RF mixer and set of phase shifters. Each antenna element may have an associated phase shifter, for example a voltage controlled phase shifter. The apparatus may also include one or more transmit antenna phased arrays, each with a set of dedicated phase shifters. Example apparatus are configured so that all phase shifters and RF mixers are included in a single RF integrated circuit. The transmit antenna arrays are mounted at different elevations, with at least one array directed towards the road surface and receiving signals from metal objects generally in the plane of the road surface. One or more additional transmit arrays are directed towards potential targets that are located on the road surface, such as other vehicles, pedestrians, animals, and the like. In this context, the target is an object providing a radar signal, which may pose a threat to the vehicle.

In an example, the radar apparatus includes two transmitter arrays, one directed towards the road surface and the other towards potential targets, and one or two receiver arrays, each array having dedicated phase shifters and a mixer. In some examples, the phase shifters and mixers for the transmit and receive arrays are all mounted on a single chip. In some examples, the arrays are dynamically reconfigurable, with the number of channels allocated to each array being adjustable. For example, additional channels may be allocated to a receive array to obtain improved resolution if desired. In other examples, a transmitter generating two beams with different elevations may adjust the number of channels used for each beam, depending on road conditions, for example using more channels for the lower elevation beam if there is a greater risk of false detections.

By combining phase shifters for both transmit and receive portions of the radar apparatus onto a single chip, the field of view of the radar can be extended, and target discrimination is improved particularly for automotive radar applications.

Examples of the present invention allow road-going targets to be discriminated from metal objects buried within the road, or otherwise close to road level. Currently, conventional radar apparatus give false responses to objects such as manhole covers and grates or pipes within the road surface, which do not pose a threat to the vehicle. A conventional ACC may implement an emergency stop in response to a large metal plate in the road. However, radar apparatus described herein use a transmit and/or receive beam, controlled by a phased array, directed towards the road surface so as to discriminate against such non-threatening metal objects. Another transmit and/or receive beam is directed forward and/or to the sides of the vehicle to detect road-going vehicles and other objects appreciably above the road surface that may pose a collision threat.

Further, the use of phased arrays on both transmit and receive sides of the apparatus allow an improved field of view to be obtained. This allows improved detection of objects at greater angles to the direction forward of the vehicle, which may be useful to detect vehicles approaching from the side.

An example radar includes an RF source, RF amplifiers, RF antenna elements, RF mixers, and (intermediate frequency) processing stages. Example radar apparatus have an improved approach to beam steering. Beam steering allows the radar apparatus to deter mine the target angle, the angle relative to the vehicle that the target is located. For example, the target angle may be measured from the direction of the vehicle or other convenient reference point. In some examples, beam steering is achieved using a single chip, which includes on chip phase shifters. Phased array steerable beams are formed at both the receive antennas and transmit antennas.

In some examples, the chip has two or more RF mixers. The use of, for example, two mixers allows two independent beams to be steered at a time, for example for both receive and transmit beams. For example, the transmitter uses the dual beam advantage by creating two beams having different elevations. A first beam is directed towards the location of expected targets on the road surface, for example towards vehicles and other obstructions within the road. A second beam is directed downwards, relative to the first beam, towards the road surface itself. The second beam allows detection of metal objects in the road, or flush with the road surface. This approach allows the radar to discriminate between targets that are genuine collision threats, and hence reduces false detections. In a conventional radar, a false detection, for example triggered by a metal object near the road surface, may result in an emergency stop. Clearly, this is an unwanted aspect that is eliminated by the current examples.

Further, example configurations allow problems associated with grating lobes to be eliminated. In some configurations, the transmitter emits radar waves over a wide field of view, and the appearance of a grating lobe in the receive beam limits the radar's field of view. However, the effects of the grating lobe can be substantially eliminated by using a phased array on both the transmit and receive beams. The grating lobe effects can be removed without sacrificing beam quality, increasing the usable field of view of the radar.

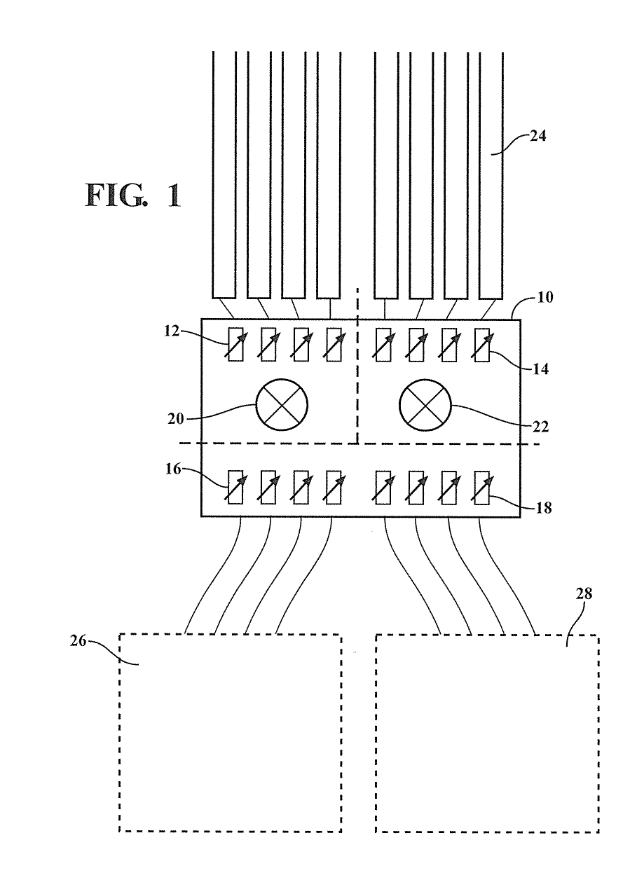

FIG. 1 is a simplified schematic showing a single RF chip 10 including receiver phase shifters at, for example, 12 and 14; transmitter phase shifters at, for example, 16 and 18; and mixers at 20 and 22. The receiver phase shifters are connected to a receive antenna array at 24. A first portion of the transmitter phase shifters is connected to a first transmit antenna array 26, and a second portion of the transmitter phase shifters 18 is connected to the second transmit antenna array at 28. The transmit antenna arrays are disposed to give different elevations within the field of view.

The electronic circuitry on the chip may be dynamically reconfigured into different operating modes. For example a single receive beam may be used, using all receive antenna array elements. In other examples, the receive antenna array may be split using a portion of the phase shifters to control a first beam, and a second portion of the phase shifters to control a second beam. Similarly, the transmit portion of the circuit can be reconfigured, for example to achieve two or more elevations if available.

An elevation may be defined as an angle relative to a plane parallel to the road surface, a horizontal plane on a non-inclined surface, a beam being directed downwards towards the road surface being low elevation beam. In some examples, a beam used to detect collision hazards may be directed at least a number of degrees higher than the low elevation beam, where the number is of degrees is 3, 5, 10 or 20 degrees higher.

The presence of two RF mixers on the chip allows two independent beams to be steered simultaneously, e.g. for both receive and transmit beam control. The transmit and receive beams may be steered together so that the associated grating nulls are angularly aligned. This allows the field of view of the radar to be increased, as it is no longer restricted by the central lobe angular width of a non-steerable beam. In some examples, there may be more than two mixers, and more than two phased arrays used.

In other examples of the present invention, a single transmit beam is used, and receive beams are received from different elevations. This approach also allows discrimination against false detections.

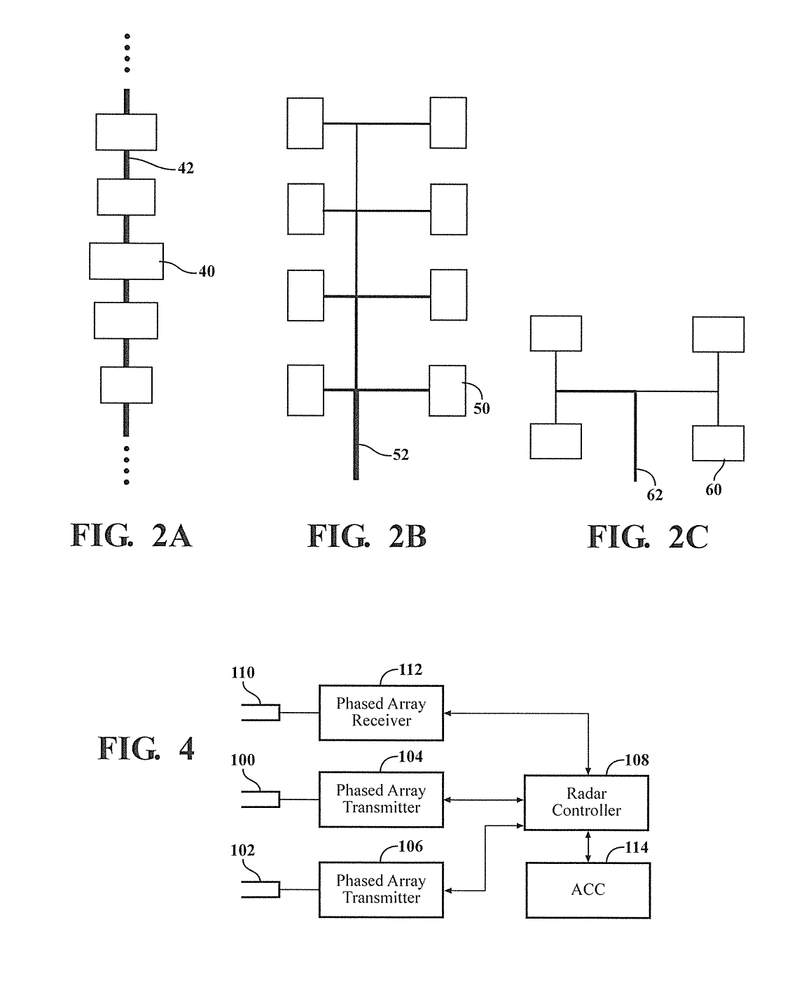

FIGS. 2A-2C show different antenna array architectures that may be used with either the transmit or receive antennas. FIG. 2A shows antenna elements 40 interconnected by electrical connections 42. FIG. 2B shows antenna radiative elements such as 50 arranged in a tree-like structure with electrical connections coming through the stripes shown at, for example, 52. FIG. 2C shows another configuration of antenna radiative elements 60 interconnected as shown by electrical connections such as 62. The illustrated antenna architectures are exemplary, and architectures that include some combination of these arrangements may be used.

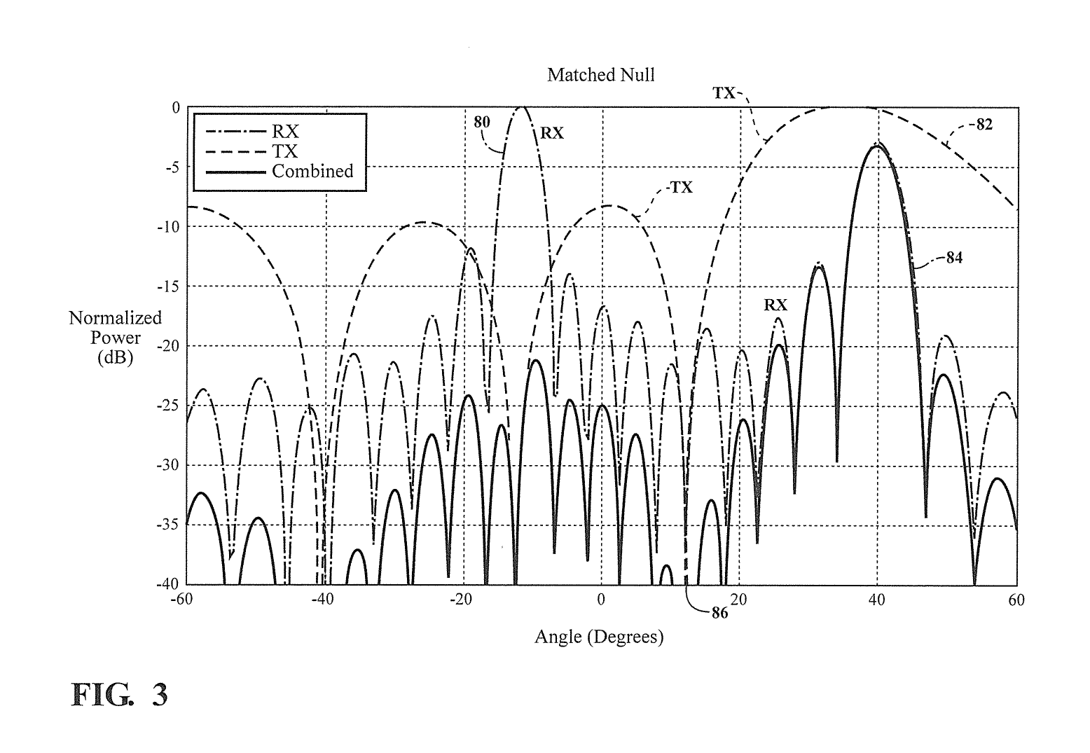

FIG. 3 is a representation of the angular properties of the receive beam (RX) 80, the transmit beam (TX) 82, and the combined response achieved from the profiles of the transmit and receive beams 84. The exact forms of the transmit and receive antennas will depend on the number and configuration of antenna radiative elements. The figure illustrates that the transmit and receive beams can be steered together so that the main lobe of the receive beam remains within the main lobe of the transmit beam. This relationship can be maintained as both beams are steered together throughout the field of view. In this way, the grating lobes of both the transmit beam and receive beam can be generally angularly aligned as both beams are steered, reducing the problems associated with the grating lobes. The grating lobes for both beams are shown approximately at 86 in this figure. However, as the beams are steered the actual angular location of a grating lobe will correspondingly change.

FIG. 4 is a highly simplified schematic showing an arrangement including a first transmit antenna array 100 (illustrated with a single antenna element for convenience, though this represents an array of antenna elements), second transmit array 102, first phased array transmitter 104, second phased array transmitter 106, radar controller (electronic control and analysis circuit) 108, receive antenna array 110, phased array receiver 112, and ACC control 114. The phased array circuits include a phase shifter for each antenna element (and may also include an amplifier and other components as required). Each phased array transmitter or receiver may also have an associated mixer. Each receive antenna element produces an antenna signal that passes through a phase shifter before reaching the mixer, with transmit antenna circuits producing a transmit signal that passes through a phase shifter before reaching the transmit antenna element.

The control circuit is used to provide electronic control signals to the phase shifters of both the transmit and receive phase shifters. For example, the phase shifters may be voltage-controlled phase shifters. By adjusting the phase shift values appropriately, steering of transmit and receive beams is obtained.

In a conventional radar device, sources of false detection such as metal road plates give rise to false detections. A false detection is a radar signal received by the radar apparatus that does not correspond to a collision hazard. However, the responses from a transmit beams directed towards the road surface can be detected and used to identify the angular locations of these sources of false detections. These beam angles either avoided or ignored during analysis of the target detection signal.

In other examples, the receive antenna may be split into two portions allowing two receive beams to be received. In such examples, the receive beams may have different elevations corresponding to the two elevations of the transmit beam. Hence, one transmit beam and one receive beam may be angularly aligned and directed in a first elevation, and a second transmit beam and second receive beam may also be angularly aligned and used to receive signals from potential targets.

In some examples, digital beam forming methods can be used to improve resolution within a real receive beam detected by the phased array receiver.

A radar controller may be an electronic circuit including a digital beam former operable to determine a virtual beam within the receive beam, the digital beam former being provided by a digital beam forming algorithm executed by a processor in the radar controller. The digital beam forming algorithm may be a MUSIC (multiple signal classification) algorithm, an ESPRIT (estimation of signal parameters via rotational invariant technique) algorithm, or other super-resolution algorithm.

The radar controller may also perform Doppler analysis of received signals, and determined direction, distance, and relative speeds of collision hazards. If a collision hazard is detected, a signal is sent to the ACC to slow the vehicle, for example by reducing engine speed, fuel flow, or applying a braking input. However, metal objects detected in the road surface may be identified as non-collision hazards or false detections, and identification of such false detections allows vehicle slowing to only be performed for other, true hazards, detected in response to a transmit beam directed above the road surface, at a higher elevation.

An improved method of operating a radar apparatus for a land vehicle traveling along a road includes: directing a first transmit beam towards the road surface, receiving signals from the first transmit beam corresponding to metal objects in the road surface, directing a second transmit beam above the road surface, detecting false collision threats using signals induced by the first beam, and detecting real collision threats using signals induced by the second beam after eliminating the false collision threats. The first and second beams may be real beams steered using phased array transmitters configured for different elevations. The signals may be detected using one or more phased array receivers.

A further improved method of operating a radar apparatus for a land vehicle includes: directing a first transmit beam towards the road surface, receiving signals from the first transmit beam corresponding to metal objects in the road surface, detecting false collision threats using signals induced by the first transmit beam, steering a second transmit beam above the road surface while avoiding angles corresponding to false collision threats, and detecting real collision threats using signals induced by the second beam. The invention is not restricted to the illustrative examples described above. Examples described are not intended to limit the scope of the invention. Changes therein, other combinations of elements, and other applications will occur to those skilled in the art.

Having described our invention, we claim:

1. An apparatus, the apparatus being a radar apparatus for a land vehicle configured to travel along a road surface, the apparatus comprising:
a first phased array transmitter, operable to generate a first transmit beam having a first elevation;
a second phased array transmitter, operable to generate a second transmit beam having a second elevation; and
a phased array receiver, operable to receive a receive beam, the receive beam including receive signals; and
a radar controller including an electronic circuit, the radar controller being operable to steer the first transmit beam, the second transmit beam, and the receive beam,
the first beam being directed towards the road surface,
the second beam being directed towards collision hazards on the road surface, the second elevation being higher than the first elevation,
the radar controller using receive signals induced by the second beam to identify collision hazards,
the radar controller using receive signals induced by the first beam to identify false detections, the false detections arising from metal objects in the road surface, the metal objects not being collision hazards.

2. The apparatus of claim 1, the receive beam and the first or the second transmit beam being steered together so that a grating null in the receive beam aligns with a grating null in the first or second transmit beam.

3. The apparatus of claim 1, the second beam being directed generally parallel to the road surface.

4. The apparatus of claim 1,
the first phased array transmitter including a first array of transmit antenna elements,
the second phased array transmitter including a second array of transmit antenna elements,
each antenna element of the first and second arrays of transmitter elements having an associated phase shifter.

5. The apparatus of claim 4, all phase shifters and at least one RF mixer being included in a single chip.

6. The apparatus of claim 4, the radar controller further being operable to dynamically reconfigure the first and second phased array transmitters, so as to adjust the numbers of antenna elements in the first and second phased array transmitters.

7. The apparatus of claim 1, the apparatus controller including a digital beam former operable to determine a virtual beam within the receive beam,
the digital beam former being provided by a digital beam forming algorithm executed by the electronic circuit in the radar controller,
the digital beam forming algorithm being selected from a group of algorithms consisting of a MUSIC (multiple signal classification) algorithm and an ESPRIT (estimation of signal parameters via rotational invariant technique) algorithm.

8. The apparatus of claim 1, including a second phased array receiver.

9. An apparatus, the apparatus being a radar apparatus for a land vehicle configured to travel along a road surface, the apparatus comprising:
phased array transmitters, operable to generate a plurality of transmit beams having different elevations; and
a phased array receiver, operable to receive a receive beam, the receive beam including receive signals; and
a radar controller including an electronic circuit, the radar controller being operable to steer the transmit beams and the receive beam,
at least one transmit beam of the plurality of transmit beams being a low elevation transmit beam directed towards the road surface, receive signals induced by the low elevation transmit beam being used to detect metal objects in the road surface.

10. The apparatus of claim 9, the receive beam being steerable together with at least one transmit beam of the plurality of transmit beams so that a receive beam grating null is angularly aligned with at least one transmit beam grating null.

11. A method of operating an automotive radar apparatus to reduce false detections of collision hazards as a vehicle travels along a road, the road having a road surface, the method including:
directing a first transmit beam towards the road surface to detect metal objects in the road surface;
directing a second transmit beam to detect collision hazards, the second transmit beam being directed above the first transmit beam;
detecting receive signals induced by the first and second transmit beams;
detecting the metal objects in the road surface using receive signals induced by the first transmit beam; and
detecting collision hazards using receive signals induced by the second transmit beam, false detection of collision hazards being reduced by detecting the metal objects in the road.

12. The method of claim 11, the collision hazards including other vehicles.

13. The method of claim 11, the metal objects in the road surface including metal plates in the road surface.
